(19) United States
(12) Patent Application Publication
(10) Pub. No.: US 2013/0269626 A1
(43) Pub. Date: Oct. 17, 2013

(54) PET SCRATCHING APPARATUS

(71) Applicant: Ashley Navran, Redlands, CA (US)

(72) Inventor: Ashley Navran, Redlands, CA (US)

(21) Appl. No.: 13/449,154

(22) Filed: Apr. 17, 2012

(51) Int. Cl. A01K 13/00

(52) U.S. Cl. 119/621

(57) ABSTRACT

A scratching apparatus having a base and body configured to removably receive a plurality of scratching units having varied textures, strengths and/or scratching elements. The body is a cylindrical-shaped tower covered with hook and loop fasteners (i.e., Velcro®) configured to receive rectangular-shaped scratching units having varied textures, strengths and/or scratching elements. The pattern of scratching units is created by the pet owner given the pet's likes and dislikes. The body may also take the form of an inverted U such that the pet may pass under a horizontal member of the body to scratch the pet's back or head and use a pair of vertical legs to scratch other body parts. The height of the horizontal member may be adjusted to accommodate different pets.

### FIELD OF THE INVENTION

The embodiments of the present invention relate to an apparatus configured to scratch pets.

### BACKGROUND

There are over 150 million domestically owned cats and dogs in the United States alone. The worldwide number is significantly larger. Many pet owners treat pets as family members and desire that their pets be pampered. One way to advance the pampering of pets is to rub, scratch and pet them.

It would be advantageous to develop an apparatus for allowing pets to scratch themselves using multiple different scratching units having varied textures, strengths and/or scratching elements.

### SUMMARY

The embodiments of the present invention relate to a scratching apparatus comprising generally a base and body configured to removably receive a plurality of scratching units wherein said scratching units have varied textures, strengths and/or scratching elements. In one embodiment, the body is a cylindrical-shaped tower covered with hook and loop fasteners (i.e., Velcro®) configured to receive rectangular-shaped scratching units having varied textures, strengths and/or scratching elements. The pattern of scratching units is created by the pet owner given the pet's likes and dislikes.

In another embodiment, the body takes the form of an inverted U such that the pet may pass under a horizontal member of the body to scratch the pet's back or head and use a pair of vertical legs to scratch other body parts. The horizontal member may be adjustable to accommodate different pets.

Other variations, embodiments and features of the present invention will become evident from the following detailed description, drawings and claims.

### BRIEF DESCRIPTION OF THE DRAWINGS

FIG. 1 illustrates a perspective view of a scratching apparatus according to the embodiments of the present invention;

FIG. 2 illustrates a top down view of the scratching apparatus of FIG. 1 according to the embodiments of the present invention;

FIG. 3 illustrates the scratching apparatus of FIGS. 1 and 2 with the scratching units removed according to the embodiments of the present invention;

FIG. 4 illustrates an inverted, U-shaped scratching apparatus according to the embodiments of the present invention;

FIGS. 5a and 5b illustrate perspective rear and top views, respectively, of a scratching unit utilized with the embodiments of the present invention;

FIG. 6 illustrates an alternative scratching unit according to the embodiments of the present invention;

FIG. 7 illustrates an alternative body incorporating slots for receipt of scratching units according to the embodiments of the present invention; and

FIG. 8 illustrates an alternative scratching unit for use with the alternative body shown in FIG. 7 according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The scratching apparatus of the embodiments of the present invention may be made of any type of suitable materials or combinations thereof including woods, plastics, metals, alloys, composites, etc.

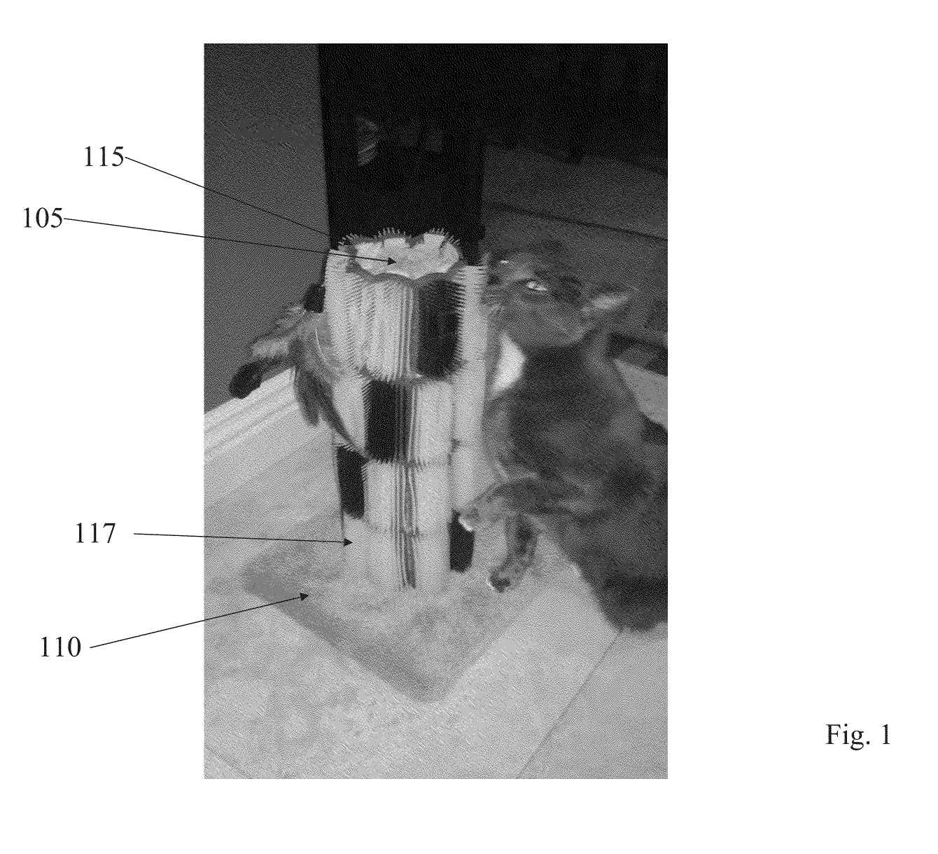

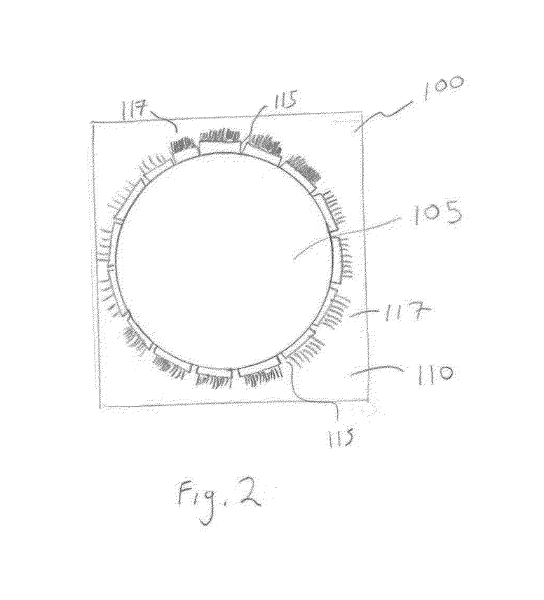

FIGS. 1 and 2 show perspective and top down views of a scratching apparatus 100 according to the embodiments of the present invention. The scratching apparatus 100 includes a body 105, base 110 and individual scratching units 115. As shown, the body 105 takes the form of a vertical cylinder and attaches to, or is integral with, the base 110. The body 105 may also take on other cross-sectional forms including that of a square, diamond, rectangle, etc. The base 110 may take on any shape including circular, square, rectangular, diamond, etc.

As shown in FIGS. 1, 2 and 5a-5b, the scratching units 115 take the form of individual rectangular elements. Those skilled in the art will recognize that the scratching units 115 may take the form of any shape beyond the rectangular shape shown. A rear surface 116 of the scratching units 115 may be flat or concave (for a cylindrical body) depending on the shape of the corresponding body 105. Different scratching units 115 provide a pet owner the ability to customize the scratching apparatus 100. The individual scratching units 115 may have scratching elements 117 of different lengths, densities, materials (e.g., plastic, hog's hair), cross-sectional shapes (e.g., circular, diamond), tip shapes (e.g., sharp, dull), hardness (e.g., soft, rigid), etc. For example, a first scratching unit may have plastic, circular scratching elements one inch in length dispersed at 20 scratching elements per square inch having sharp tips while a second scratching unit may have composite, blade-shaped scratching elements two inches in length dispersed at 10 scratching elements per square inch having dull tips.

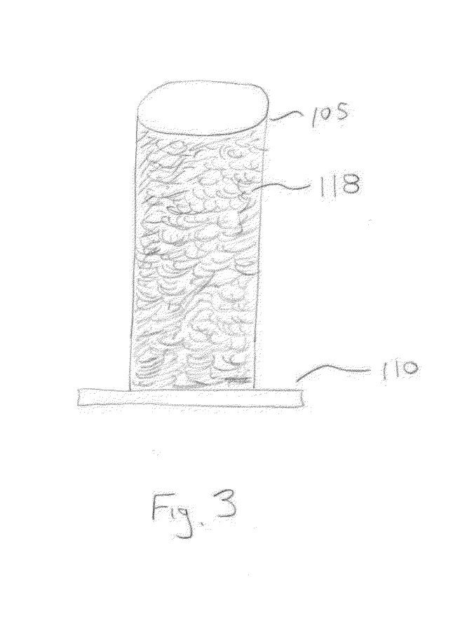

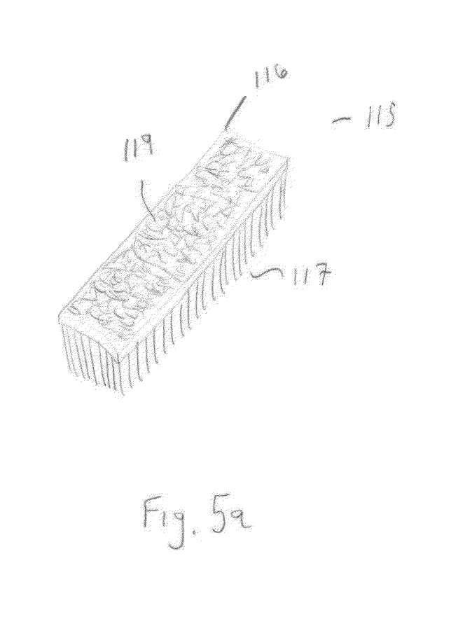

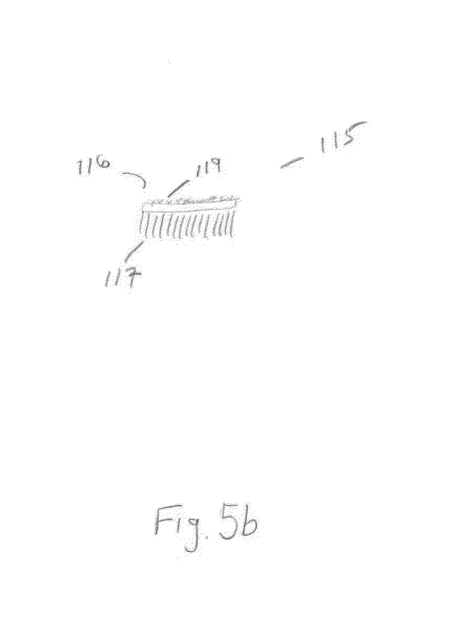

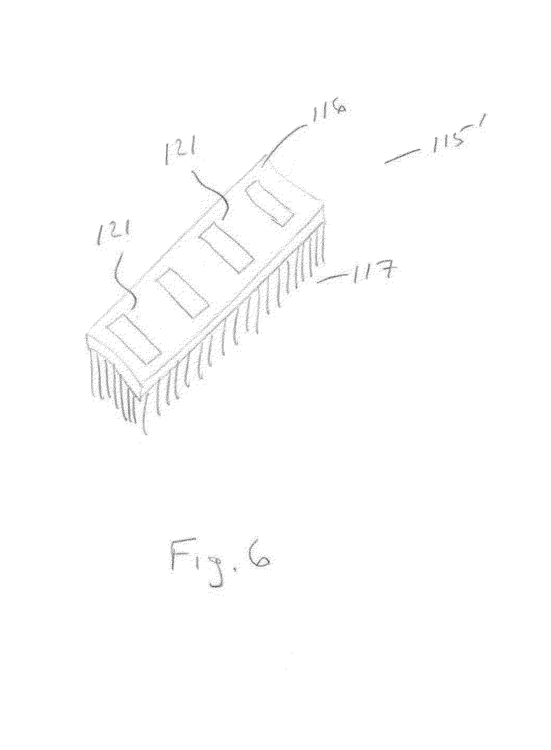

FIG. 3 shows the scratching apparatus of FIGS. 1 and 2 without the scratching units 115 in place. As shown, the body 105 is covered with material which allows the scratching units 115 to be removably attached thereto. In one embodiment, the body 105 is covered, at least partially, with hook and loop fasteners 118 (e.g., Velcro® or other material (e.g., carpeting)) and as shown in FIGS. 5a and 5b, the rear surfaces 116 of the scratching units 115 incorporate at least a section of hook and loop fasteners 119 compatible therewith such that the materials join together. In another embodiment, the body 105 is fabricated of a metallic alloy and the scratching units 115′ incorporate one or more magnets 121 (see FIG. 6) or alternatively the body 105 is magnetic and the scratching units 115 are metallic or incorporate one or more metallic members.

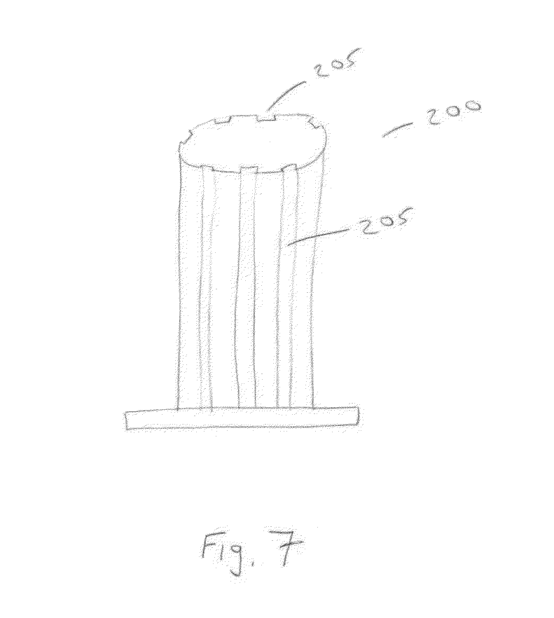

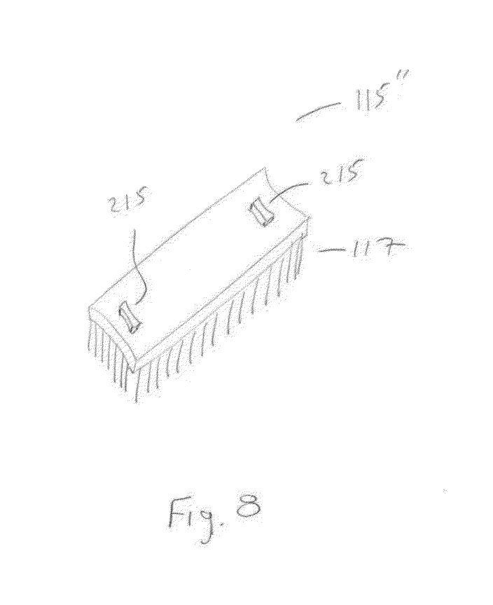

FIG. 7 shows an alternative embodiment of a body 200 having multiple vertical slots 205 for receipt of scratching units 115″ (shown in FIG. 8) having one or more pins 215. The pins 215 are configured to slide into, and be retained by, the slots 205.

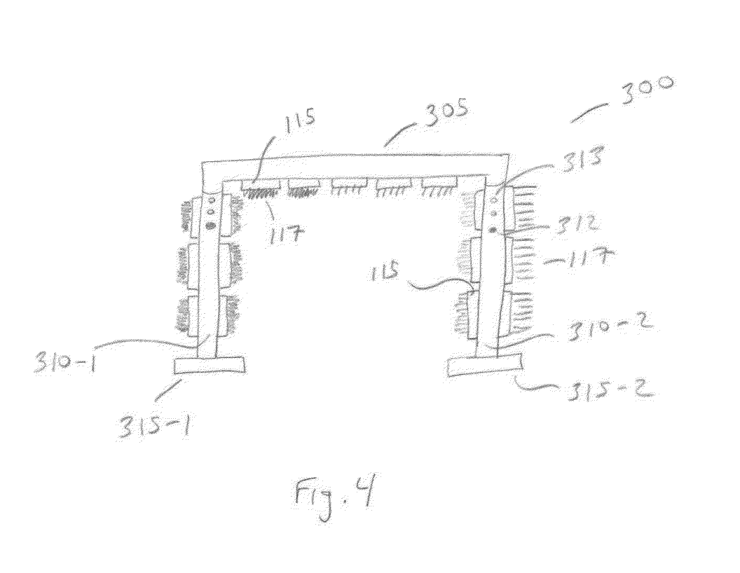

FIG. 4 shows a inverted, U-shaped scratching apparatus 300 comprising a horizontal member 305 and two, spaced vertical members 310-1, 310-2. Each of the two, spaced vertical members 310-1, 310-2 rest on, or are integral with, individual base members 315-1, 315-2. With this embodiment, the pet is able to walk beneath the horizontal member to scratch hard-to-reach back and head areas. In one embodiment, the two, spaced vertical members 310-1, 310-2 can be raised and lowered using conventional spring-biased pins 312 and corresponding spaced openings 313 integrated in telescoping articles forming the vertical members 310-1, 310-2.

Regardless of the configuration of the scratching apparatus, the different scratching units with the attachment means provides a mechanism for a pet owner to customize the scratching apparatus by positioning the scratching units in a desired pattern on the body. The removable individual scratching units also permit easy cleaning.

Although the invention has been described in detail with reference to several embodiments, additional variations and modifications exist within the scope and spirit of the invention as described and defined in the following claims.

I claim:

1. An apparatus comprising:
a base;
a body supported by said base;
multiple scratching units removably attachable to said body, said scratching units each including a plurality of scratching elements; and
wherein said body and scratching units are configured such that said body may be substantially covered with scratching units.

2. The apparatus of claim 1 wherein said body and rear surfaces of said scratching units include compatible hook and loop fasteners.

3. The apparatus of claim 1 wherein said body is fabricated, at least partially, of a metallic material and said scratching units include one or more magnetic members.

4. The apparatus of claim 1 wherein said scratching units are fabricated, at least partially, of a metallic material and said body includes one or more magnetic members.

5. The apparatus of claim 1 wherein said body includes multiple vertical slots.

6. The apparatus of claim 5 wherein said scratching units include one or more pins extending from rear surfaces thereof.

7. The apparatus of claim 1 wherein said scratching elements of said multiple scratching units have one or more of the following: differing lengths, differing scratching element densities, differing materials, differing cross-sectional shapes, differing tip shapes and differing hardnesses.

8. An apparatus comprising:
a body comprising a horizontal member and two vertical members;
individual bases supporting each of said two vertical members;
multiple scratching units removably attachable to said body, said scratching units including a plurality of scratching elements; and
wherein said body and scratching units are configured such that said body may be substantially covered with scratching units.

9. The apparatus of claim 8 wherein said body and rear surfaces of said scratching units include compatible hook and loop fasteners.

10. The apparatus of claim 8 wherein said body is fabricated, at least partially, of a metallic material and said scratching units includes one or more magnetic members.

11. The apparatus of claim 8 wherein said scratching units are fabricated, at least partially, of a metallic material and said body includes one or more magnetic members.

12. The apparatus of claim 8 wherein said horizontal member includes multiple horizontal slots.

13. The apparatus of claim 8 wherein said vertical members include multiple vertical slots.

14. The apparatus of claim 12 wherein said scratching units include one or more pins extending from rear surfaces thereof.

15. The apparatus of claim 13 wherein said scratching units include one or more pins extending from rear surfaces thereof.

16. The apparatus of claim 8 wherein said scratching elements of said multiple scratching units have one or more of the following: differing lengths, differing scratching element densities, differing materials, differing cross-sectional shapes, differing tip shapes and differing hardnesses.

17. The apparatus of claim 8 wherein a height of said horizontal member is vertically adjusted via said vertical members.

18. An apparatus comprising:
a body covered at least partially with a material compatible with hook and look fasteners;
a base supporting said body; and
a plurality of scratching units including at least a section of hook and loop fasteners on rear surfaces thereof for permitting said scratching units to be removably attached to said body, said scratching units including a plurality of scratching elements.

19. The apparatus of claim 18 wherein said scratching elements of said multiple scratching units have one or more of the following: differing lengths, differing scratching element densities, differing materials, differing cross-sectional shapes, differing tip shapes and differing hardnesses.

20. The apparatus of claim 18 wherein said body comprises a horizontal member, two vertical members and a base supporting each vertical member.

21. The apparatus of claim 20 wherein a height of said horizontal member is vertically adjusted via said vertical members.
